(19) United States
(12) Patent Application Publication
(10) Pub. No.: US 2010/0193094 A1
(43) Pub. Date: Aug. 5, 2010

(54) Scented Tires

(76) Inventor: Ronald John Rosenberger, Newtown, PA (US)

Correspondence Address: Guy Kevin Townsend, 1079 S. VAN GORDON COURT, LAKEWOOD, CO, 80228, US

(21) Appl. No.: 12/755,307

(22) Filed: Apr. 6, 2010

Related U.S. Application Data
(63) Continuation of application No. 10/822,049, filed on Apr. 10, 2004, now abandoned.
(60) Provisional application No. 60/463,653, filed on Apr. 17, 2003.

(51) Int. Cl. B60C 11/24; B60C 5/00; B60C 11/00

(52) U.S. Cl. 152/154.2; 152/450; 152/209.17

(57) ABSTRACT

Tires for vehicles comprising at least one scented rubber compound and/or at least one scented non-rubber component. Additionally disclosed is where one or more pheromones are used, in addition to or in place of, the scent or fragrance of the pertinent rubber compound(s) or non-rubber component(s), and where scent is used as a wear warning in place of, or in addition to, the novelty scented rubber compound and/or novelty scented non-rubber component. Wear warning mechanisms other than scent are presented. Also disclosed is a plug or insert comprising varied attributes including, or in place of, scent that enables customization, where at least one plug or insert may be installed in the above-mentioned vehicle tires, and in other vehicle tires as well.

### CROSS REFERENCE TO RELATED APPLICATIONS

This application claims the benefit of U.S. Provisional Patent Application Ser. No. 60/463,653, filed Apr. 17, 2003.

### BACKGROUND OF THE INVENTION

The Prior Art shows numerous examples of patents being awarded for inventions where the addition of scent to articles used in everyday living.

U.S. Pat. No. 6,666,900 issued Dec. 23, 2003, to Chandaria, describes a Scented Firelog.

U.S. Pat. No. 6,656,256 issued Dec. 2, 2003, to Moreland, describes Scented Jet Printer Ink.

U.S. Pat. No. 6,430,764 issued Aug. 13, 2002, to Peters, describes an Herbal-Scented Pillow.

U.S. Pat. No. 6,415,741 issued Jul. 9, 2002, to Suchowski et al, describes a Scented Chew Toy.

U.S. Pat. No. 6,381,984 issued May 7, 2002, to Russo, et al, describes Scented Jewelry.

U.S. Pat. No. 6,357,260 issued Mar. 19, 2002, to Lutz, describes a Scented Bracelet Kit.

U.S. Pat. No. 6,217,242 issued Apr. 17, 2001, to Cote, describes a Scented Writing Implement.

U.S. Pat. No. 6,012,963 issued Jan. 11, 2000, to Lee, describes a Scented Doll Assembly.

U.S. Pat. No. 5,826,598 issued Oct. 27, 1998, to Meehan, describes a Scented Hair Accessory.

U.S. Pat. No. 5,817,385 issued Oct. 6, 1998, to Stanislav, describes a Scented Transferable Tattoo.

U.S. Pat. No. 5,795,644 issued Aug. 18, 1998, to Delarosa, describes Scented Bubble Wrap.

U.S. Pat. No. 5,779,519 issued Jul. 14, 1998, to Oliver, describes a Scented Fingernail File and Buffer.

U.S. Pat. No. 5,110,584 issued May 5, 1992, to Medri, et al describes Scented Nail Enamels.

U.S. Pat. No. 5,077,102 issued Dec. 31, 1991, to Chong, describes a Scented Artificial Flower.

U.S. Pat. No. 4,762,493 issued Aug. 9, 1988, to Anderson, describes Scented Crayons.

U.S. Pat. No. 4,283,011 issued Aug. 11, 1981, to Spector, describes a Scented Sticker.

### SUMMARY OF THE INVENTION

One embodiment of the present invention is a rubber vehicle tire, such as an automobile tire, where the rubber compound or formulation comprising the tire is enhanced with a scent or fragrance. The intended purpose of embellishing a tire with a scent or fragrance is to provide a marketable feature to end-users. For example, car owners are known to spent considerable amounts of time and money customizing their vehicles with an endless assortment of special items, whether it is a two kilowatt audio system, a custom paint job, alloy wheels, special lighting systems, etc. The car customization industry is ever growing, with some owners making considerable personal sacrifices in order to afford the latest trend in vehicle customization. Motorcycles are another cause of spending, where, regardless of the economy, there seem to be many individuals willing to plunk down thirty, forty, or fifty thousand dollars, and often more, for a highly customized, boutique motorcycle. Such consumers are perfect candidates for novelty scented motorcycle tires.

In many scent related disclosures not having anything to do with the present invention, scent is used to mask offensive odors, such as room deodorizers. This is not the case with the present invention, where the aroma due to the scent or fragrance added to a given vehicle tire is a salient, distinguishing, and marketable feature of the tire, and may comprise any desired scent or fragrance. The scented tire gives off an aroma when at rest, or when the tire is in use. Friction and heat buildup due to use is an effective means of releasing the aroma, and wear of the vehicle tire serves to expose fresh surface area of the novelty scented rubber compound or formulation.

Many customized car or motorcycle owners enjoy “smoking” their tires, which is caused by engaging the braking system of the car or motorcycle while “mashing” the gas pedal or throttle, thus causing the tire(s) to spin against the pavement, and produce smoke. It appears reasonable that such users could enjoy the practice even more if the produced “smoke” was imbued with pleasant aromas such as vanilla, lemon, cherry, etc., or even less usual scenting aromas, such as beer, flatulence, or cannabis, as a result of the novelty scented rubber compound or formulation.

Scented tires could have an appeal to more reserved drivers as well. Many individuals enjoy the “new car smell”, so much so that a new vehicle that features novelty scented tires, where the novelty scent consists of the “new car smell”, may be used as a selling point for a particular brand of new car. Such would present an opportunity for prospective buyers to not only “kick the tires” when shopping for a new car, but to bend over and smell them as well. While some could consider such an aspect to be trivial, the aspect at least gives the salesman one more way to engage in or continue a sales discussion with a prospect. Also, a given tire may incorporate an aroma, scent, or fragrance that shows evidence of stimulating a buying behavior, either for the tires themselves, or for the vehicle being the tires.

Scented tires could also provide a means of product differentiation for the manufacturer as well. For instance, a given tire manufacturer tends to have at least several large nationwide tire retailers selling its products. Such a manufacturer can offer a given retailer a special distinguishing novelty scent offering not available to the other retailers, without changing or compromising the performance, tread design, and/or safety features of the basic tire product. Also, the manufacturer can choose to offer “limited editions” of novelty scented tires, such as doing limited runs of a new aroma for a given model of tire at a given periodic interval.

Also, any kind of pheromone or pheromones may be used in addition to, or in place of the novelty scent or fragrance agents in a tire. For example, pheromones that suggest or indicate the ability to attract members of a desired gender can be used in a given tire, and may possibly help a young man that “smokes” his tires to be regarded as a heartthrob, instead of a jerk, by young women witnessing such behavior. Pheromones that suggest or indicate the ability to induce a buying behavior can prove very useful, such as where tires that incorporate one or more such pheromone(s), or combination of pheromone(s) and novelty scent or fragrance, can induce a buying behavior for the tires themselves, or for the vehicle that said tires are affixed. Such would enable a given vehicle maker that is the only maker to employ tires comprising pheromones to have a unique and effective means of promotion, being that vehicles that have already been sold and are traveling the highways are interacting with and influencing prospective buyers everywhere due to the pheromone(s) content of the tires.

Also disclosed is where scent is used as a wear warning for a vehicle tire, and other types of wear warnings are presented as well. Finally, a less invasive means for scenting a vehicle tire comprising a novelty plug or insert is disclosed. The novelty plug or insert comprises varied attributes in addition to, or in place of, scent that enables customization of the disclosed tire and in other vehicle tires as well.

### DETAILED DESCRIPTION OF THE INVENTION

The disclosed scented vehicle tire may be realized in myriad ways and combinations. Scent may be made apparent in the vehicle tire by incorporating novelty scent or fragrance in or on the rubber compound(s) comprising a given vehicle tire, in or on the any of the non-rubber components of a given tire, or on any combination of a given tire's rubber compound(s) and non-rubber components.

Any of the countless formulations of vehicle tire rubber compound may incorporate novelty scent or fragrance using any possible means, comprising where at least one (with more than one being a possibility) novelty scent or fragrance is added as an ingredient to one or more of the tire's rubber compound(s); where one or more novelty scent or fragrance capsules or microcapsules comprising at least one novelty scent or fragrance are placed in any of the rubber compounds of the tire itself, where the capsulated means ruptures with exposure due to wear, thereby releasing the novelty scent or fragrance; etc. A less desirable, yet disclosed embodiment is where at least one novelty scent or fragrance is externally applied to the rubber, and is not intrinsic to the rubber compound itself, which can occur at any time in the process, such as before, during, or after the finished tire is molded and/or vulcanized. For purposes of this disclosure, rubber materials comprising any possible means of novelty scent or fragrance enhancement is known as novelty scented rubber compound.

Any of a vehicle tire's non-rubber components, comprising items such as tire plies or steel belts, may incorporate novelty scent or fragrance, using any means for doing so. For example, capsules or microcapsules of novelty scent or fragrance may be embedded in any of the non-rubber components of the tire, such as the steel belt or plies of the tire. Also, the non-rubber components of the tire may be coated and/or formulated with novelty scent or fragrance, such as coating and/or formulating the steel belt(s) or plies of the tire with novelty scent or fragrance.

Regardless of the method or embodiment, what is important is that the aroma that results from adding novelty scent or fragrance to a given vehicle tire is a salient, distinguishing, and marketable feature of the tire, and is not intended to merely mask the intrinsic smell of the tire per se.

The scenting agent(s) for the novelty scented rubber compound may comprise any scent producing agent(s) such as those comprising, but not limited to, water, oil, or glycol soluble scents, in any range of fragrance concentration that achieves the desired aesthetic result. The aroma of the scenting agent(s) may comprise any desired aroma, such as citrus scents (lemon, orange, etc.), fruity scents (coconut, cherry, etc.), spice scents (cinnamon, vanilla, etc.), to the abovementioned less usual scenting aromas (beer, flatulence, cannabis, etc.). Also, the scenting agent(s), as used in the novelty scented rubber compound and/or non-rubber tire components, may comprise any kind(s) of pheromone(s) in place of, or in addition to, the abovementioned at least one novelty scent or fragrance.

Novelty scented vehicle tires may comprise tires for any vehicle, such as: tires for vehicles comprising automobiles, sports utility vehicles and minivans; very large tires, such as tires for vehicles comprising heavy machinery work vehicles, “monster” trucks, farm equipment, and aircraft; large tires for commercial vehicles comprising trucks and buses; tires for motorcycle type vehicles comprising motorcycles, scooters, or motorbikes; tires for miscellaneous vehicles comprising all-terrain vehicles, golf carts, or go carts; and tires for bicycle type vehicle, comprising bicycles, unicycles, tricycles, or even exercise bikes.

Also, it is known in the art for a singular tire to have multiple occurrences of rubber compound, such as one type of rubber compound for the tread, another type of rubber compound for the rubber coated plies of a tire, and other rubber compound components of a tire, such as a sidewall, or the tire valve stem. It is also possible to have a tread comprising more than one type of rubber compound, or for the tread to comprise separate segments of the same rubber compound, either across the width of the total tire tread, or in layers along the depth of the tread. Of these “multiple occurrences” of scented rubber compound, it is disclosed that a vehicle tire can comprise “at least one” of these scented rubber compounds comprise novelty scented rubber compounds. Also, it is possible, in the instance of a tire that uses a plurality of novelty scented rubber compounds, for the scent of each of the said plurality of novelty scented rubber compounds to comprise the same, similar, or different scents. This presents the opportunity for interesting variants. For example, a tire tread can have two (or more) layers of differently scented rubber compounds, where the outside half of the tire tread depth gives off a cherry aroma, then when the tread wears down, the inside half of the tire tread depth gives off a lemon aroma.

Also, it is possible for the disclosed vehicle tire to comprise “at least one” scented non-rubber tire component. Furthermore, the tire may comprise a plurality of novelty scented non-rubber components, where the scent of each of the said plurality of novelty scented non-rubber components could comprise the same, similar, or different scents and/or pheromones. It is disclosed that a given scented vehicle tire can comprise “at least one” novelty scented rubber compound and/or “at least one” novelty scented non-rubber component.

Given the range of potential implementations regarding scented rubber compounds, scented non-rubber components, the range of potential scents or fragrances, the combining of varied scents or fragrances in the same scented rubber compounds and/or non-rubber components, and/or allowing different scents in each of a plurality of separate rubber compounds and/or non-rubber components, not to mention the numerous types of vehicle tires, the range of embodiments for a scented vehicle tire is indeed large.

This invention can also include where strategic placement of scented rubber compounds acts as a wear warning for excess tire wear. It is possible for the disclosed vehicle tire to comprise novelty scented rubber, or even old and well known non-scented rubber, for the normal wear components of a given tire, such as for the tread, until the tire becomes worn to a level predetermined to warrant replacement. At the predetermined wear level, a different, wear warning scented rubber compound is presented, where the emergence of the scented material releases a warning aroma comprising any desired severity. The predetermined wear level could comprise any desired parameter such as any percentage of remaining tire tread, or wear-through of any tire area or component. Such a scented rubber compound wear warning aroma could comprise any desired scent, such as a char smell, or a sulfuric smell, such as one resembling rotten eggs. Wear warning scents may comprise any other non-rubber components in addition to or in place of the scented rubber compound, such as having encapsulated means such as capsules or microcapsules of wear warning scent that expose and rupture due to wear embedded in the rubber itself, or in any of the non-rubber components of the tire, such as the steel belt or plies of the tire, or scenting the non-rubber components of the tire themselves, such as coating or formulating the steel belt or tire plies with wear warning scent. As mentioned above, the tire may also comprise novelty scented rubber and/or non-rubber components in addition to rubber and/or non-rubber components comprising the wear warning scent. For instance, the outer circumference of the tire tread can have a pleasant cherry scent, whereas, say, the inside ten percent of the circumference of the tire tread, or the exposed surface of a ply or a belt on a severely worn tire, can give off a sulfuric stench.

The wear warning scent can act as a type of wear warning means. Another type of wear warning means that may be emitted is in the form of a visible wear warning, that is rendered visible in the form of a smoke, powder, or viscous solution that oozes out over the tire. Any means for rendering a visible wear warning may be employed, such as friction against a newly exposed rubber compound or non-rubber component comprising the visible wear warning means, the exposing and rupturing due to wear of encapsulating means such as capsules or microcapsules that releases the visible wear warning means, etc. In the case of smoke, the smoke may comprise any color, which is useful in helping an end user identify the source of the smoke. For example, a visible wear warning means may comprise bright green smoke, which would alleviate concern that the smoke is due to an engine problem, being that engine problems tend to not produce bright green colored smoke. A powder, such as a bright pink powder that optionally leaves a residue on the tire, may be used. In the case of the viscous solution that oozes out of the tire, the viscous solution may comprise any desired composition, color, or viscosity, preferably one that can easily be removed from car finishes.

Also, it is disclosed as an option to have the intensity of the wear warning means to be proportional to the wear level of the wear warning means. Simply stated, the more severe the wear, the more apparent or intense the wear warning means becomes.

An option for a given tire manufacturer is to offer colored tires comprising novelty scented rubber compound that is colored in accordance to the scent of the novelty scented rubber compound, such as red for a cherry scented tire, orange for an orange scented tire, yellow for lemon or banana scented tire, etc. The tire may comprise colored rubber only, such as where the entire tire is red or orange; or, the tire may comprise a colored feature, so instead of having a “whitewall” tire with a band of white material, end users can have an “orange wall” tire with a band of orange material, all while the tire gives off the aroma of oranges. Also, it is possible to modify the above to have a colored scented tire where the color and the novelty scent are incongruous, such as having a blue tire that gives off the aroma of vanilla, or a pink tire that gives off the aroma of chocolate.

Another means by which to scent the tire is by using a plug or an insert, where the plug comprises erodible material comprising at least one novelty scent or fragrance and/or pheromone. For purposes of this disclosure, such a plug or insert comprising novelty scent or fragrance will be referred to as a novelty plug or insert. As will be seen, the novelty plug or insert is useful for scenting purposes, or for purposes in addition to, or in place of scenting purposes. While the preferred embodiments comprise novelty scent or fragrance and/or pheromones, numerous potential embodiments may include novelty plugs or inserts that do not comprise novelty scent or fragrance and/or pheromones, but employ other attributes that will be disclosed.

The scented plug or insert is intended to be installable on the outside surface of a tire. While theoretically the novelty plug or insert should be installable anywhere on the outside surface of the tire, it is apparent that the most optimal situation would place the novelty plug or insert comprising erodible material in the tread of the tire, with the novelty plug or insert exposed and visible on the tire's tread. Such an embodiment would permit friction and heat build-up, as well as wear, that would stimulate the release of the added scent or fragrance. For this reason, it is preferred that the outside surface of the novelty plug or insert be flush with the outside tire surface, and not be recessed in any way. The plug or insert can be installed on the disclosed vehicle tire that comprises scented rubber compound and/or scented non-rubber component, and/or pheromones, and/or wear warning oriented rubber compound and/or wear warning oriented non-rubber components, or it may be installed on tires that do not comprise any or all of the abovementioned attributes.

The plug or insert can comprise any shape, design, size or depth. For example, the plug or insert may appear in the tire as being circular in shape, a quarter inch wide and a quarter inch deep; or, shaped like the State of Texas, an inch across; or, can comprise a lined design, such as a Celtic symbol an inch and a half high. Also, the novelty plug or insert can comprise any embodiment of an “O” ring around the tread circumference or tire wall diameter of the vehicle tire.

The plug or insert can comprise any color, or if desired, colors. The plug or insert can comprise any erodible material composition; however, the erodible material that is ultimately used should be carefully considered, because if the erodible material is too hard compared to the tire rubber, excess noise and/or a rough ride can result. If the erodible material is too soft, then excess road debris can get lodged in the erodible material. A good choice among the many potentially usable erodible materials would be compounds comprising silica that enable scenting, coloration, and other manipulations.

The erodible material composition can also comprise the appearance of the plug or insert, which will be known as a visual aspect. A visual aspect comprises any unique or interesting appearance item or items. Such items may be reflective, refractive, sparkling, shining, holographic, jewel-like, luminescent, pearlescent, fluorescent, glow-in-the dark, etc. For instance, the erodible material composition could comprise silver glitter, or pearlescent granules, or day-glow fluorescent orange reflective material, any of which would visually “pop” on a rotating tire, especially at night with headlights shined on the tire.

The plug or insert can also comprise a wear warning plug or insert, where the wear warning plug or insert is able to be oriented in the tire in such a way that allows deployment to occur at a predetermined level of tire wear. The wear warning plug or insert can comprise any erodible material composition that uses wear warning means, such as wear warning scent, and/or visible wear warning colored or non-colored smoke. Also, the wear warning plug or insert may use, in addition to or in place of the erodible material composition that uses wear warning means, any encapsulated means, where the encapsulated means uses capsules or microcapsules that rupture due to exposure and wear, thereby releasing wear warning means comprising wear warning scent, and/or either visible wear warning non-colored/colored smoke, visible wear warning powder that can optionally leave a residue, or visible wear warning viscous solution comprising any composition, color, or viscosity. Smoke may be attained using any means, such as through a chemical reaction, or the release of a powder that deploys airborne particles. Furthermore, it may be desirable to have the intensity of the wear warning means proportional to the wear level of the vehicle tire and/or wear warning means, as in the more severe the wear, the more apparent or intense the wear warning means becomes.

A singular plug or insert can be as simple or sophisticated as desired, and may comprise any one, or any combination or permutation comprising more than one, of the following attributes: one or more erodible material(s); one or more color(s); one or more scent(s) and/or fragrance(s); one or more pheromone(s); one or more visual aspect(s); or one or more wear warning means.

The plug or insert may comprise a plug or insert comprising multi-sectional construction, where a singular plug or insert comprises two or more sections, where any one given section, or even two or more sections, can be oriented either along the depth of the plug or insert, and/or along or across the surface area that is visible on the tire after installation (where the two or more sections are side by side; or, where two or more sections are side by side, over top of a third section that is hidden underneath). Furthermore, any one given section can comprise any one, or any combination or permutation comprising more than one, of the following attributes: one or more erodible material(s); one or more color(s); one or more scent(s) and/or fragrance(s); one or more pheromone(s); one or more visual aspect(s); or one or more wear warning means. The combinations are endless and versatile. For instance, a singular plug or insert comprising two sections (a top and bottom section) along the depth can have a cherry scented red glitter section adjacent to the tread surface of a new tire; then, when the tire and the plug or insert both wear down, the bottom section of the plug or insert comprising a lemon scented yellow glitter section is revealed. Likewise, the top section of a plug or insert can comprise pink glitter that smells like bubblegum, or be just an unscented black top section, that wears down to the abovementioned wear warning mechanism that gives off a blue residue powder or orange smoke, and smells like dead fish.

As mentioned earlier, the plug or insert can be installed on the disclosed vehicle tire that comprises scented rubber compound and/or scented non-rubber component, and/or pheromones, and/or wear warning oriented rubber compound and/or wear warning oriented non-rubber components, or it may be installed on tires not comprising any of the abovementioned attributes. What is important is that the vehicle tire comprises at least one void anywhere on the outside surface of the tire, where the void comprises a receptacle that is intended for and allows for the insertion of at least one plug or insert. A given void or receptacle can comprise a hole of any shape, design, directional orientation, size, or depth. Also, a void can comprise a groove, channel, or crevice comprising any shape, design, design pattern, directional orientation, size, or depth. Furthermore, it is possible that a groove, channel, or crevice can be formed on the vehicle tire to accommodate a plug or insert comprising any embodiment of an “O” ring around the circumference of the tire tread, or around the diameter of the sidewall of the vehicle tire. It may be desirable for a given void or receptacle to accommodate two or more plugs or inserts, either along the depth of said void, side-by-side along/across the opening gap of said void, or both. Such could be useful in a situation where a singular plug or insert comprising wear warning means is situated beneath a singular plug or insert comprising a pheromone.

It is intended that a given plug or insert is designed, or is able to be modified, to be inserted in a corresponding void or receptacle of the vehicle tire by any possible insertion means, either automatically by machine, or by hand with or without the use of tools. Also, it is intended that a given plug or insert can be secured in the corresponding void or receptacle of the vehicle tire using any securing means, whether said plug or insert is integrated before or during vulcanization, glued in, pressure-fitted, heat set, screwed in, set using grooves or serrations on the plug and/or the tire, etc. Finally, it could possibly be desirable that a given plug or insert be removed from the vehicle tire for whatever reason. Any removal means may be contemplated as an antidote to overcome prior installation, even if such removal means are as basic as using a drill or a dremel tool to remove the plug or insert.

Plugs or inserts may be either factory installed on the vehicle tire prior, during, or after the vulcanization process, or may be installed on the vehicle tire by non-factory aftermarket installers, such as tire retailers, mechanics, customizers, end users, etc.

Installation may comprise any number and/or combination of different plugs or inserts, where differences comprising a given scented plug or insert can comprise any variation with regards to any one or more of the following: erodible material(s); color(s); scent(s) and/or fragrance(s); pheromone(s); visual aspect(s); wear warning means, single section construction versus multi-sectional construction, etc., where the use of different plugs or inserts allows for the customization of said vehicle tire to comprise endless variants and permutations, such as having a singular tire that comprises forty voids with forty corresponding plugs or inserts, where ten of the plugs or inserts are red sparkle cherry scented, ten of the plugs or inserts are white sparkle vanilla scented, ten of the plugs or inserts are blue sparkle berry scented, with the remaining ten of the of the plugs or inserts comprising wear warning means. The end result becomes a patriotic red, white, and blue tire that smells like a fruit salad, that also knows when it is time to quit.

Plugs or inserts can be made available and/or sold as a separately offered aftermarket item or items, to allow customization of the disclosed vehicle tire comprising at least one void by aftermarket installers. Also, the disclosed plugs or inserts can be used to customize tires other than the disclosed vehicle tire comprising at least one void through the modification of tires other than the disclosed vehicle tire, where the modification enables installation of the disclosed plugs or inserts.

Modifications and variations within the scope of the disclosure should be apparent to those with ordinary skill in the art.

1-17. (canceled)

18. A vehicle tire comprising an outside surface of at least one of a tread, a belt or a ply, wherein said outside surface comprises:
a. at least one void comprising a receptacle for at least one scented plug, insert, or o-ring on said outside surface; and
b. at least one scented plug, insert, or o-ring comprising at least one added fragrance,
wherein
(1) said added fragrance is released when said plug, insert, or o-ring is at rest, or when said plug, insert, or o-ring is in use due to friction, heat buildup, and wear; and
(2) wherein said vehicle tire is selected from a vehicle tire for at least one of an automobile, a sport utility vehicle, a minivan, a heavy machinery work vehicle, a truck, a farm equipment vehicle, an aircraft, a bus, a motorcycle, a scooter, a motorbike, an all-terrain vehicle, a golf cart, a go cart, a bicycle, a unicycle, a tricycle, or an exercise bike.

19. The vehicle tire of claim 18, wherein said scented plug, insert, or o-ring further comprises at least one selected from an added pheromone, a color, a reflective visual component, a refractive visual component, a sparkling visual component, a shining visual component, a holographic visual component, a jewel-like visual component, a pearlescent visual component, a fluorescent visual component, or a glow-in-the dark visual component.

20. The vehicle tire of claim 18, further comprising wherein at least one fragrance or pheromone is added to the materials of said vehicle tire, wherein said fragrance or pheromone is released when said outside surface is at rest, and when said outside surface is in use due to friction, heat buildup, and wear.

21. The vehicle tire of claim 18, further comprising wherein said vehicle tire comprises at least one wear warning component added to the materials of said vehicle tire comprising at least one of a wear warning scent, a visible wear warning non-colored or colored smoke, a visible wear warning powder that optionally leaves a residue, or a visible viscous solution that optionally leaves a residue, optionally wherein the intensity or timing of the release of said wear warning component is proportional to the wear level of said vehicle tire.

22. The vehicle tire of claim 18, further comprising wherein said plug, insert, or o-ring comprises at least one wear warning component comprising at least one of a wear warning scent, visible wear warning non-colored or colored smoke, visible wear warning powder that optionally leaves a visible residue, or a visible viscous solution that optionally leaves a visible residue, optionally wherein the intensity or timing of the release of said wear warning component is proportional to the wear level of said vehicle tire.

23. A vehicle tire, comprising an outside surface of at least one of a tread, a belt or a ply, wherein said vehicle tire comprises at least one added pheromone, wherein said vehicle tire is selected from a vehicle tire for at least one of an automobile, a sport utility vehicle, a minivan, a heavy machinery work vehicle, a truck, a farm equipment vehicle, an aircraft, a bus; a motorcycle, a scooter, a motorbike, an all-terrain vehicle, a golf cart, a go cart, a bicycle, a unicycle, a tricycle, or an exercise bike.

24. The vehicle tire of claim 23, wherein said vehicle tire comprises at least one added pheromone added to the materials of said vehicle tire, optionally where at least one fragrance is added to said materials of said vehicle tire, wherein said pheromone and said fragrance is released when said vehicle tire is at rest, and when said vehicle tire is in use due to friction, heat buildup, and wear.

25. The vehicle tire of claim 23, wherein said outside surface comprises:
a. at least one void comprising a receptacle for at least one plug, insert or o-ring;
b. at least one plug, insert, or o-ring comprising said at least one added pheromone; and,
c. optionally further comprising at least one pheromone or fragrance that is added to the materials of said vehicle tire.
wherein said pheromone or fragrance is released when said, plug, insert, o-ring or outside surface is at rest, or when said plug, insert, o-ring or outside surface is in use due to friction, heat buildup, and wear.

26. The vehicle tire of claim 23, wherein said plug, insert, or o-ring further comprises at least one selected from an added color, a reflective visual component, a refractive visual component, a sparkling visual component, a shining visual component, a holographic visual component, a jewel-like visual component, a pearlescent visual component, a fluorescent visual component, or a glow-in-the dark visual component.

27. The vehicle tire of claim 23, further comprising wherein said vehicle tire comprises at least one wear warning component added to the materials of said vehicle tire comprising at least one of a wear warning scent, a visible wear warning non-colored or colored smoke, a visible wear warning powder that optionally leaves a residue, or a visible viscous solution that optionally leaves a residue, optionally wherein the intensity or timing of the release of said wear warning component is proportional to the wear level of said vehicle tire.

28. The vehicle tire of claim 23, further comprising wherein said plug, insert, or o-ring comprises at least one wear warning component comprising at least one selected from a wear warning scent, visible wear warning non-colored or colored smoke, visible wear warning powder that optionally leaves a visible residue, or a visible viscous solution that optionally leaves a visible residue, optionally wherein the intensity or timing of the release of said wear warning component is proportional to the wear level of said vehicle tire.

29. A vehicle tire comprising an outside surface of at least one of a tread, a belt or a ply, wherein said vehicle tire comprises at least one added wear warning component, wherein said vehicle tire is selected from a vehicle tire for at least one of an automobile, a sport utility vehicle, a minivan, a heavy machinery work vehicle, a truck, a farm equipment vehicle, an aircraft, a bus, a motorcycle, a scooter, a motorbike, an all-terrain vehicle, a golf cart, a go cart, a bicycle, a unicycle, a tricycle, or an exercise bike.

30. The vehicle tire of claim 29, wherein said vehicle tire comprises a wear warning component comprising at least one added wear warning scent, optionally wherein the intensity or timing of the release of said wear warning component is proportional to the wear level of said vehicle tire.

31. The vehicle tire of claim 29, wherein said vehicle tire comprises at least one wear warning component comprising at least one of an added visible wear warning non-colored or colored smoke, visible wear warning powder that optionally leaves a visible residue, or a visible viscous solution that optionally leaves a visible residue, optionally wherein the intensity or timing of the release of said wear warning component is proportional to the wear level of said vehicle tire.

32. The vehicle tire of claim 29, wherein said added wear warning component is added to the materials of said vehicle tire.

33. The vehicle tire of claim 29, wherein said added wear warning component comprises
a. at least one void comprising a receptacle for at least one scented plug, insert, or o-ring on said outside surface; and
b. at least one scented plug, insert, or o-ring comprising said added wear warning component; and
c. optionally further comprising where said wear warning component is added to the materials of said vehicle tire.

34. The vehicle tire of claim 29, wherein said wear warning component deploys due to friction against newly exposed a) rubber compound comprising said wear warning component, b) non-rubber component comprising said wear warning component; or, c) encapsulated means such as capsules or microcapsules comprising said wear warning component.
